(19) United States
(12) Patent Application Publication
(10) Pub. No.: US 2023/0058490 A1
(43) Pub. Date: Feb. 23, 2023

(54) SYNAPTIC CIRCUIT AND NEURAL NETWORK APPARATUS

(71) Applicant: KABUSHIKI KAISHA TOSHIBA, Tokyo (JP)

(72) Inventors: Kumiko Nomura, Shinagawa Tokyo (JP); Yoshifumi Nishi, Yokohama Kanagawa (JP); Takao Marukame, Chuo Tokyo (JP); Koichi Mizushima, Kamakura Kanangawa (JP)

(73) Assignee: KABUSHIKI KAISHA TOSHIBA, Tokyo (JP)

(21) Appl. No.: 17/688,171

(22) Filed: Mar. 7, 2022

(30) Foreign Application Priority Data
Aug. 20, 2021 (JP) 2021-134794

(51) Int. Cl. G06N 3/04; G06N 3/08

(52) U.S. Cl. CPC G06N 3/04; G06N 3/08

(57) ABSTRACT

A synaptic circuit according to an embodiment includes a weight storage circuit and a transmission circuit. The weight storage circuit stores a synaptic weight indicating a first value or a second value. The transmission circuit receives a firing signal output from a pre-synaptic neuron circuit, and supplies an output signal to a post-synaptic neuron circuit. The output signal is obtained by adding, to the firing signal, influence of the synaptic weight. The post-synaptic neuron circuit holds an internal potential. When the firing signal is received, the weight storage circuit causes the synaptic weight to change to indicate the first or second value with a first probability in accordance with a comparison result between the internal potential and a set potential. The weight storage circuit causes the synaptic weight to change to indicate the first value with a second probability regardless of whether or not the firing signal is received.

### CROSS-REFERENCE TO RELATED APPLICATIONS

This application is based upon and claims the benefit of priority from Japanese Patent Application No. 2021-134794, filed on Aug. 20, 2021; the entire contents of which are incorporated herein by reference.

### FIELD

Embodiments described herein relate generally to a synaptic circuit and a neural network apparatus.

### BACKGROUND

In recent years, a technology for implementing a neuromorphic processor by using a hardware-based neural network has been proposed. The neuromorphic processor includes, for example, a neuron circuit and a synaptic circuit. The synaptic circuit stores a synaptic weight, and supplies, to a post-synaptic neuron, a signal obtained by adding influence of the synaptic weight to a signal received from a pre-synaptic neuron. The neuron circuit holds an internal potential. The neuron circuit increases or decreases the internal potential according to a signal output from the synaptic circuit connected to a preceding stage. The neuron circuit outputs a firing signal in accordance with the magnitude of the internal potential.

The synaptic weight is updated by a given learning method. As a learning method of a neuromorphic processor, for example, there is a method of updating the synaptic weight according to an internal potential held in a post-synaptic neuron circuit at the time of firing a pre-synaptic neuron circuit.

In addition, from the viewpoint of simplification of the circuit and the like, it is preferable that the neuromorphic processor handles the synaptic weight with a binary number. When handling a binary synaptic weight, the neuromorphic processor stochastically updates the synaptic weight in accordance with the internal potential held by the post-synaptic neuron circuit, for example. There is a demand for accurately learning such a synaptic weight.

### BRIEF DESCRIPTION OF THE DRAWINGS

FIG. 1 is a configuration diagram of a neural network apparatus according to an embodiment;

FIG. 2 is a diagram illustrating a connection relation among synaptic circuits;

FIG. 3 is a configuration diagram of a pre-synaptic neuron circuit, a post-synaptic neuron circuit, and a synaptic circuit;

FIG. 4 is a configuration diagram of a weight storage circuit;

FIG. 5 is a timing chart of a signal related to a learning instruction circuit;

FIG. 6 is a timing chart of a first setting signal, a second setting signal, and a synaptic weight;

FIG. 7 is a configuration diagram of a weight control circuit;

FIG. 8 is a timing chart of a first example of a signal of the weight control circuit;

FIG. 9 is a timing chart of a second example of a signal of the weight control circuit;

FIG. 10 is a configuration diagram of a reservoir computing apparatus according to an embodiment; and

FIG. 11 is a diagram illustrating accuracy with respect to the number of times of learning.

### DETAILED DESCRIPTION

A synaptic circuit according to an embodiment includes a weight storage circuit and a transmission circuit. The weight storage circuit stores a synaptic weight indicating a first value or a second value. The transmission circuit receives a firing signal output from a pre-synaptic neuron circuit, and supplies an output signal to a post-synaptic neuron circuit. The output signal is obtained by adding, to the firing signal, influence of the synaptic weight stored by the weight storage circuit. The post-synaptic neuron circuit holds an internal potential varying in response to reception of the output signal. When the firing signal is received from the pre-synaptic neuron circuit, the weight storage circuit performs comparison to determine whether or not the internal potential held by the post-synaptic neuron circuit is equal to or higher than a set potential, and causes the synaptic weight to change to indicate the first value or the second value with a first probability set in advance in accordance with a comparison result as to whether or not the internal potential is equal to or higher than the set potential. The weight storage circuit causes the synaptic weight to change to indicate the first value with a preset second probability regardless of whether or not the firing signal is received from the pre-synaptic neuron circuit.

Hereinafter, a neural network apparatus 10 according to an embodiment will be described with reference to the drawings.

In a neuromorphic processor that implements a neural network handling a synaptic weight with a binary number, erroneous learning may occur on a synaptic weight. For example, when a pre-synaptic neuron of a synapse did not fire by accident, the neuromorphic processor may erroneously change a synaptic weight of the synapse to be a low value (e.g., 0) although this synapse should have originally stored a high value (e.g., 1) of a synaptic weight. In the neuromorphic processor handling the synaptic weight with a binary number, when such erroneous learning occurs, the internal potential held by the post-synaptic neuron hardly varies thereafter, and thus it is difficult to return the synaptic weight to a correct high value (e.g., 1). For this reason, it is necessary for the neuromorphic processor handling the synaptic weight with a binary number to resolve the deterioration in accuracy of the synaptic weight caused by such erroneous learning. For such a problem, the neural network apparatus 10 according to the embodiment is implemented by hardware, and can accurately learn the synaptic weight. As a result, the neural network apparatus 10 according to the embodiment can execute accurate inference.

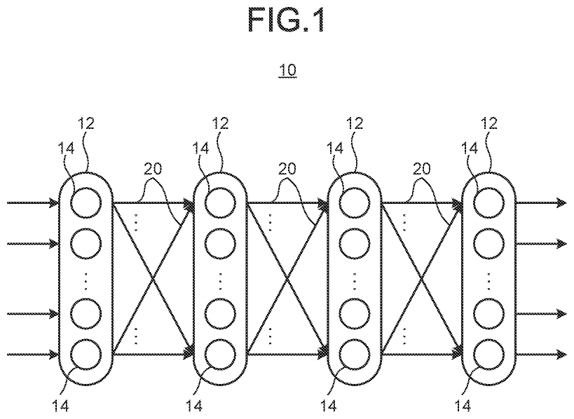

FIG. 1 is a diagram illustrating an example of the neural network apparatus 10 according to the embodiment. As an example, the neural network apparatus 10 includes N-stage layers 12 (N is an integer equal to or larger than 2), and synaptic circuits 20 each functioning as a synapse in the neural network. Each of the N-stage layers 12 includes neuron circuits 14 each functioning as a neuron in the neural network.

The neuron circuits 14 acquire firing signals output from the pre-synaptic layer 12. Each of the firing signals is transmitted via any one of the synaptic circuits 20.

The first-stage layer 12 of the N-stage layers 12 acquires signals from an external device or from an input layer. Then, each of the neuron circuits 14 performs integration processing on the acquired signals, performs activation function processing on a value obtained by the integration processing, and outputs a firing signal. Each of the neuron circuits 14 executes the integration processing and the activation function processing by an analog circuit, for example. In the present embodiment, each of the neuron circuits 14 holds an internal potential V as a result of the integration processing on the acquired signals.

Each of the synaptic circuits 20 stores a synaptic weight. The synaptic weight indicates a binary number of a first value or a second value. In the present embodiment, the first value indicates the higher one of the two values, and is H logic or 1, for example. In the present embodiment, the second value indicates the lower one of the two values, and is L logic or 0, for example. The synaptic weight stored in each of the synaptic circuits 20 is set by learning processing.

For example, each of the synaptic circuits 20 connecting the (n)-th-stage layer 12 and the (n+1)-th-stage layer 12 receives the firing signal output from one neuron circuit 14 of the neuron circuits 14 included in the (n)-th-stage layer 12. The synaptic circuits 20 connecting the (n)-th-stage layer 12 and the (n+1)-th-stage layer 12 each generates an output signal obtained by adding, to the received firing signal, influence of the stored synaptic weight, and supplies the generated output signal to one of the neuron circuits 14 included in the (n+1)-th-stage layer 12.

In such neural network apparatus 10, the first-stage layer 12 receives one or more signals from an external device or from an input layer. Then, the neural network apparatus 10 outputs, from the N-th-stage layer 12, one or more signals indicating the result of performing calculation on the one or more received signals by the neural network.

Note that the neural network apparatus 10 is not limited to the configuration illustrated in FIG. 1, and may be configured in accordance with a recurrent neural network such as a reservoir. In this case, at least one of the synaptic circuits 20 feeds back the output signal to supply it to the neuron circuit 14.

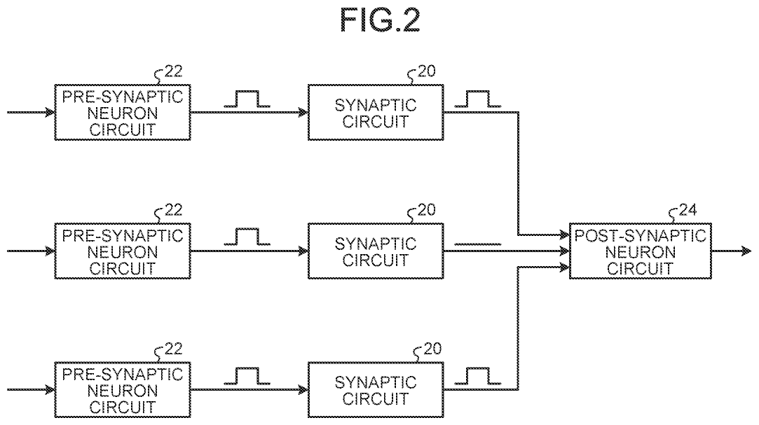

FIG. 2 is a diagram illustrating the connection relation among the synaptic circuits 20. The synaptic circuit 20 receives a firing signal from a pre-synaptic neuron circuit 22 which is any one of the neuron circuits 14 included in the pre-synaptic layer 12. The synaptic circuit 20 outputs an output signal obtained by adding, to the received firing signal, influence of the stored synaptic weight. Then, the synaptic circuit 20 gives the output signal to the corresponding post-synaptic neuron circuit 24.

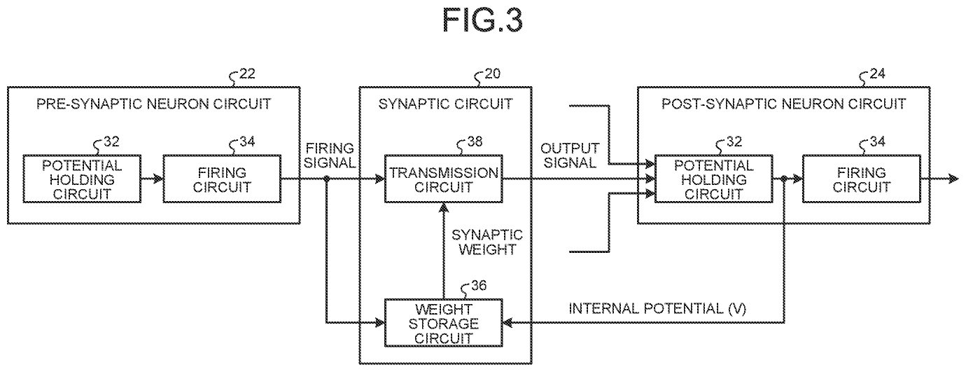

FIG. 3 is a diagram illustrating the configuration of the pre-synaptic neuron circuit 22, the post-synaptic neuron circuit 24, and the synaptic circuit 20. Each of the neuron circuits 14 holds the internal potential V that varies in response to reception of the output signal. Then, the neuron circuits 14 each output a firing signal in accordance with the held internal potential V.

The pre-synaptic neuron circuit 22 and the post-synaptic neuron circuit 24 each include, for example, a potential holding circuit 32 and a firing circuit 34.

The potential holding circuit 32 receives output signals from the synaptic circuits 20. When any of the output signals is received, the potential holding circuit 32 increases the internal potential V by a given amount. In addition, the potential holding circuit 32 may decrease the internal potential V as time passes in a period during which the output signal is not received. The potential holding circuit 32 may include a capacitor, for example. In this case, when the output signal is received, the potential holding circuit 32 charges the capacitor with a given amount of charge. In addition, the potential holding circuit 32 discharges, with the lapse of time, the charge held in the capacitor in a period during which no output signal is received. Due to this, the potential holding circuit 32 can increase the internal potential V by the given amount when any output signal is received, and can decrease the internal potential V with the lapse of time in the period during which no output signal is received. With regard to the internal potential V held by the neuron circuit 14, it may be, for example, “postsynaptic neuron V” described in Joseph M. Brader et al., “Learning real-world stimuli in a neural network with spike-driven synaptic dynamics”, Neural computation, Volume 19, Massachusetts Institute of Technology, P2881-2912, November 2007.

The firing circuit 34 outputs a firing signal when the internal potential V held by the potential holding circuit 32 exceeds a preset threshold. In the present embodiment, the firing circuit 34 outputs the firing signal becoming H logic at the firing start timing and becomes L logic after a given time elapses from the firing start timing. That is, in the present embodiment, the firing circuit 34 changes the firing signal from L logic to H logic at the firing start timing at which the internal potential V becomes larger than the preset threshold. Then, the firing circuit 34 changes the firing signal from H logic to L logic after a given time elapses from the firing start timing. Note that the firing circuit 34 may stochastically output the firing signal when the internal potential V becomes larger than the preset threshold.

The synaptic circuit 20 includes a weight storage circuit 36 and a transmission circuit 38.

The weight storage circuit 36 stores a synaptic weight indicating the first value or the second value. When the firing signal is received from the pre-synaptic neuron circuit 22, the weight storage circuit 36 compares, with a set potential V_{SET}, the internal potential V held by the post-synaptic neuron circuit 24, and determines whether or not the internal potential V is equal to or higher than the set potential V_{SET}. Then, the weight storage circuit 36 causes the synaptic weight to change to indicate the first value or the second value with a first probability, which is set in advance, in accordance with a comparison result as to whether or not the internal potential V is equal to or higher than the set potential V_{SET}.

For example, in response to receiving the firing signal from the pre-synaptic neuron circuit 22, the weight storage circuit 36 changes the synaptic weight to indicate the first value with the first probability when the internal potential V is equal to or higher than the set potential V_{SET} and the stored synaptic weight indicates the second value. More specifically, it is assumed that the first probability is A (A is a value larger than 0 and smaller than 1). In this case, in response to receiving the firing signal, when the internal potential V is equal to or higher than the set potential V_{SET} and the stored synaptic weight indicates the second value, the weight storage circuit 36 changes the synaptic weight to indicate the first value with the probability of A, and maintains the synaptic weight at the second value with the probability of (1−A). Note that, when the internal potential V is equal to or higher than the set potential V_{SET} and the synaptic weight indicates the first value, the weight storage circuit 36 maintains the synaptic weight at the first value.

In addition, in response to receiving the firing signal from the pre-synaptic neuron circuit 22, the weight storage circuit 36 changes the synaptic weight to indicate the second value with the first probability when the internal potential V is smaller than the set potential V_{SET} and the stored synaptic weight indicates the first value. More specifically, in response to receiving the firing signal, when the internal potential V is smaller than the set potential V_{SET} and the stored synaptic weight indicates the first value, the weight storage circuit 36 changes the synaptic weight to indicate the second value with the probability of A, and maintains the synaptic weight at the first value with the probability of (1−A). Note that, when the internal potential V is smaller than the set potential V_{SET} and the synaptic weight indicates the second value, the weight storage circuit 36 maintains the synaptic weight at the second value.

It is assumed that the firing signal is a signal indicated by a binary number of L logic or H logic. Then, it is assumed that the firing signal becomes H logic at the firing start timing of the pre-synaptic neuron circuit 22 and becomes L logic after a given time elapses from the firing start timing. In this case, the weight storage circuit 36 compares, with the set potential V_{SET}, the internal potential V of the post-synaptic neuron circuit 24 at the first timing at which the firing signal changes from L logic to H logic. Then, the weight storage circuit 36 causes the synaptic weight to change to indicate the first value or the second value with the first probability on the basis of the comparison result at the second timing at which the firing signal changes from H logic to L logic immediately after the first timing.

When the correlation between the output of the firing signal from the pre-synaptic neuron circuit 22 and the internal potential V held in the post-synaptic neuron circuit 24 is strong, the weight storage circuit 36 may learn the synaptic weight so as to strengthen the mutual relationship between the pre-synaptic neuron circuit 22 and the post-synaptic neuron circuit 24. On the other hand, when the correlation between the output of the firing signal from the pre-synaptic neuron circuit 22 and the internal potential V held in the post-synaptic neuron circuit 24 is weak, the weight storage circuit 36 may learn the synaptic weight so as to weaken the mutual relationship between the pre-synaptic neuron circuit 22 and the post-synaptic neuron circuit 24.

Moreover, regardless of whether the firing signal has been received from the pre-synaptic neuron circuit 22, the weight storage circuit 36 causes the synaptic weight to change to indicate the first value with the preset second probability. Note that the second probability is a value smaller than the first probability. The weight storage circuit 36 causes the synaptic weight to change to indicate the first value with the second probability every preset time, for example. Note that, as mentioned above, the second probability is lower than the first probability. For example, the second probability is a very minute value of about 0.0001.

For example, the weight storage circuit 36 causes the synaptic weight to change to indicate the first value with the second probability every preset time independent of the firing signal output from the pre-synaptic neuron circuit 22. Such the weight storage circuit 36 can return, with the second probability, the synaptic weight to the first value being a correct value regardless of the output of the firing signal, even if erroneous learning was performed such that the synaptic weight is changed to indicate the second value for the reason that a firing signal was not output from the pre-synaptic neuron circuit 22 by accident although the synaptic weight indicating the first value should have been originally stored.

Note that, when the firing signal becomes H logic at the firing start timing of the pre-synaptic neuron circuit 22 and becomes L logic after a given time elapses from the firing start timing, the weight storage circuit 36 may cause the synaptic weight to change to indicate the first value with the second probability in a period during which the firing signal is L logic. As a result, the weight storage circuit 36 can cause the synaptic weight to change to indicate the first value with the second probability without temporally interfering with the learning processing of the synaptic weight in response to the output of the firing signal from the pre-synaptic neuron circuit 22.

The transmission circuit 38 receives the firing signal output from the pre-synaptic neuron circuit 22. The transmission circuit 38 then supplies to the post-synaptic neuron circuit 24 an output signal obtained by adding, to the received firing signal, influence of the synaptic weight stored by the weight storage circuit 36.

For example, when the transmission circuit 38 receives the firing signal from the pre-synaptic neuron circuit 22 and the synaptic weight stored by the weight storage circuit 36 is the first value, the transmission circuit 38 supplies the output signal to the post-synaptic neuron circuit 24. For example, when the transmission circuit 38 receives the firing signal from the pre-synaptic neuron circuit 22 and the synaptic weight stored by the weight storage circuit 36 is the second value, the transmission circuit 38 does not give the output signal to the post-synaptic neuron circuit 24. Alternatively, for example, when the transmission circuit 38 receives the firing signal from the pre-synaptic neuron circuit 22 and the synaptic weight stored by the weight storage circuit 36 is the second value, the transmission circuit 38 may supply the output signal to the post-synaptic neuron circuit 24 at a timing later than a timing at which the output signal is supplied to the post-synaptic neuron circuit 24 in a case where the synaptic weight indicates the first value. Due to this, the transmission circuit 38 can supply, to the post-synaptic neuron circuit 24, an output signal obtained by adding influence of the synaptic weight stored by the weight storage circuit 36 to the received firing signal.

The above-described transmission circuit 38 can perform, in an analog manner, multiplication processing of multiplying the firing signal in the neural network by the synaptic weight.

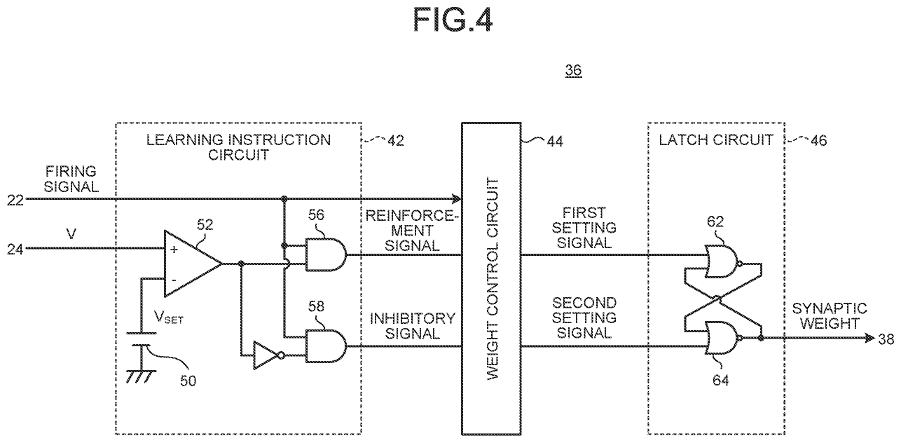

FIG. 4 is a diagram illustrating the configuration of the weight storage circuit 36. The weight storage circuit 36 includes, for example, a learning instruction circuit 42, a weight control circuit 44, and a latch circuit 46.

The learning instruction circuit 42 includes a set potential generation circuit 50, a comparator 52, a first AND circuit 56 in the instruction circuit, and a second AND circuit 58 in the instruction circuit.

The set potential generation circuit 50 generates the set potential V_{SET}. The comparator 52 compares the internal potential V held by the post-synaptic neuron circuit 24 and the set potential V_{SET} generated from the set potential generation circuit 50. The comparator 52 outputs a comparison signal that becomes H logic when the internal potential V is equal to or higher than the set potential V_{SET} and becomes L logic when the internal potential V is lower than the set potential V_{SET}. An inversion circuit 54 in the instruction circuit outputs a signal obtained by logically inverting the comparison signal output from the comparator 52.

The first AND circuit 56 in the instruction circuit performs an AND operation on the comparison signal output from the comparator 52 and the firing signal. The first AND circuit 56 in the instruction circuit outputs, as a reinforcement signal, a signal indicating the result of the AND operation of the comparison signal and the firing signal.

The second AND circuit 58 in the instruction circuit performs an AND operation on a signal obtained by logically inverting the comparison signal by the inversion circuit 54 in the instruction circuit and the firing signal. The first AND circuit 56 in the instruction circuit outputs, as an inhibitory signal, a signal indicating the result of the AND operation of the signal obtained by logically inverting the comparison signal and the firing signal.

Such the learning instruction circuit 42 can output a reinforcement signal that becomes H logic in a period during which the firing signal is H logic and the internal potential V is equal to or higher than the set potential V_{SET} and becomes L logic in other periods. In addition, the learning instruction circuit 42 can output an inhibitory signal that becomes H logic in a period during which the firing signal is H logic and the internal potential V is smaller than the set potential V_{SET}, and becomes L logic in other cases.

The weight control circuit 44 receives the reinforcement signal, the inhibitory signal, and the firing signal. Then, the weight control circuit 44 outputs the first setting signal and the second setting signal.

The first setting signal is a signal for causing the stored synaptic weight to change to indicate the first value. In the present embodiment, the change from L logic to H logic of the first setting signal indicates causing the synaptic weight to change to indicate the first value. The second setting signal is a signal for causing the stored synaptic weight to change to indicate the second value. In the present embodiment, the change from L logic to H logic of the second setting signal indicates causing the synaptic weight to change to indicate the second value.

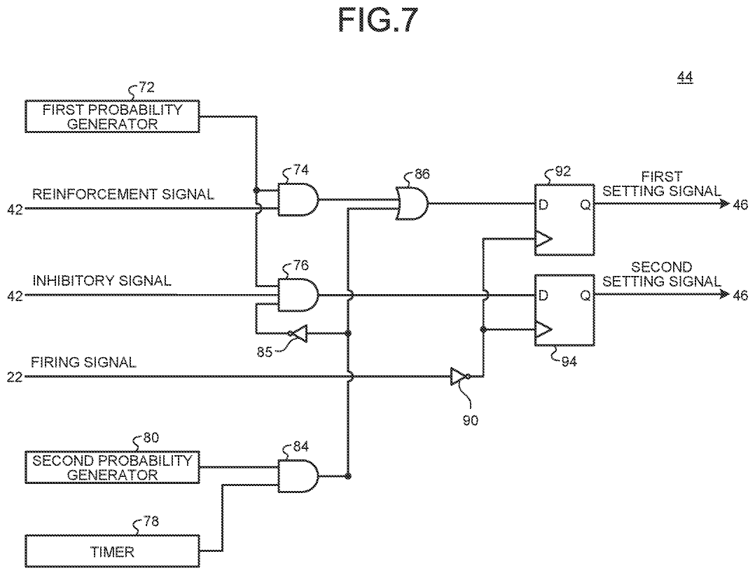

Note that the configuration of the weight control circuit 44 will be described later with reference to FIG. 7.

The latch circuit 46 stores the synaptic weight. The latch circuit 46 then outputs, to the transmission circuit 38, a signal indicating the value of the stored synaptic weight. The latch circuit 46 stores the first value or the second value as the synaptic weight. In the present embodiment, the latch circuit 46 stores H logic as the first value and stores L logic as the second value.

When the first setting signal changes from L logic to H logic in a state where the latch circuit 46 stores the second value (L logic), the latch circuit 46 causes the stored value to change to indicate the first value (H logic). When the first setting signal changes from L logic to H logic in a state where the latch circuit 46 stores the first value (H logic), the latch circuit 46 maintains the stored value at the first value (H logic).

When the second setting signal changes from L logic to H logic in a state where the latch circuit 46 stores the first value (H logic), the latch circuit 46 causes the stored value to change to indicate the second value (L logic). When the second setting signal changes from L logic to H logic in a state where the latch circuit 46 stores the second value (L logic), the latch circuit 46 maintains the stored value at the second value (L logic).

The latch circuit 46 includes, for example, a first NOR circuit 62 in the latch and a second NOR circuit 64 in the latch. The first NOR circuit 62 in the latch receives the first setting signal and a signal output from the second NOR circuit 64 in the latch, and outputs a signal obtained by performing an NOR operation on the first setting signal and the signal output from the second NOR circuit 64 in the latch. The second NOR circuit 64 in the latch receives the second setting signal and a signal output from the first NOR circuit 62 in the latch, and outputs a signal obtained by performing an NOR operation on the second setting signal and the signal output from the first NOR circuit 62 in the latch. Then, in this case, the latch circuit 46 outputs, as the synaptic weight, the signal output from the second NOR circuit 64 in the latch.

The latch circuit 46 may be formed by using an SR latch circuit including such two NOR circuits described above. Note that the latch circuit 46 may have any configuration as long as the circuit can store L logic or H logic and switch the values stored by the first setting signal and the second setting signal. For example, the latch circuit 46 may be, for example, an SR latch circuit including two NAND circuits, or may be an SR latch circuit including two inverters and two resistors.

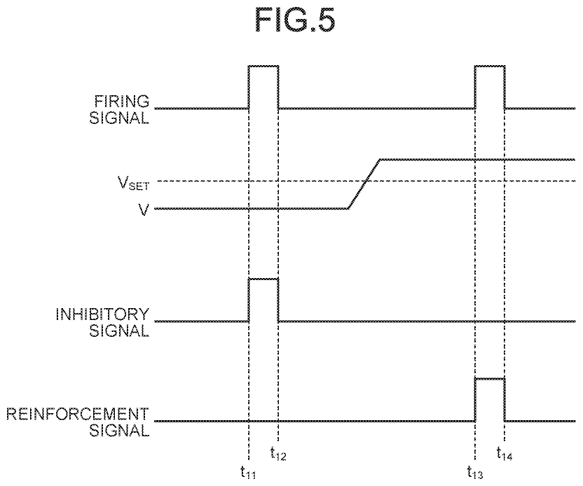

FIG. 5 is a timing chart of a signal related to the learning instruction circuit 42.

it is assumed that the firing signal changes from L logic to H logic in a period during which the internal potential V is smaller than the set potential V_{SET} and changes from H logic to L logic after a given time elapsed, as in the period between time t₁₁ and time t₁₂ illustrated in FIG. 5. In this case, in synchronization with the firing signal, the inhibitory signal changes from L logic to H logic at time t₁₁ and changes from H logic to L logic at time t₁₂. In the period during which the internal potential V is smaller than the set potential V_{SET}, the reinforcement signal becomes L logic regardless of the firing signal.

Moreover, it is assumed that the firing signal changes from L logic to H logic in a period during which the internal potential V is equal to or higher than the set potential V_{SET}, and changes from H logic to L logic after a given time elapsed, as in the period between time t₁₃ and time t₁₄ in FIG. 5. In this case, in synchronization with the firing signal, the reinforcement signal changes from L logic to H logic at time t₁₃ and changes from H logic to L logic at time t₁₄. In the period during which the internal potential V is equal to or higher than the set potential V_{SET}, the inhibitory signal becomes L logic regardless of the firing signal.

In this manner, the learning instruction circuit 42 can set the reinforcement signal to H logic when the internal potential V is equal to or higher than the set potential V_{SET} in the period during which the firing signal is H logic. The learning instruction circuit 42 can set the inhibitory signal to H logic when the internal potential V is smaller than the set potential V_{SET} in the period during which the firing signal is H logic.

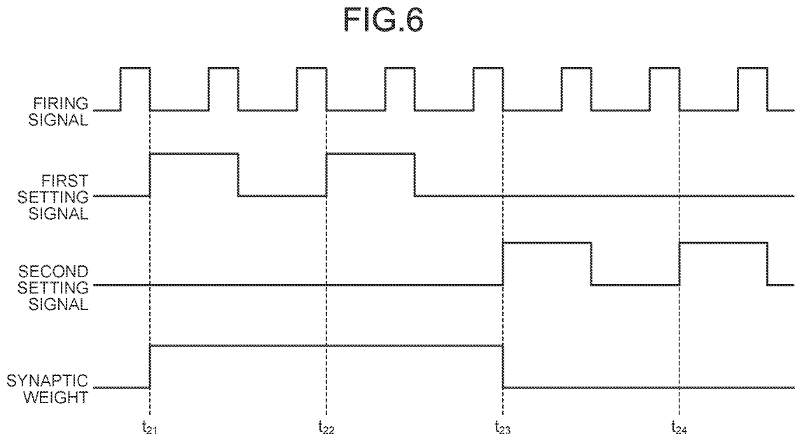

FIG. 6 is a timing chart of the firing signal, the first setting signal, the second setting signal, and the synaptic weight.

The first setting signal changes from L logic to H logic in a case where the synaptic weight held in the latch circuit 46 is caused to change to indicate the first value (e.g., H logic). The second setting signal changes from L logic to H logic in a case where the synaptic weight held in the latch circuit 46 is caused to change to indicate the second value (e.g., L logic). The first setting signal and the second setting signal each change from L logic to H logic at a falling edge (timing when changing from H logic to L logic) of the firing signal. After changing from L logic to H logic, the first setting signal and the second setting signal each change from H logic to L logic at the falling edge of the firing signal.

As indicated at time t₂₁, when the first setting signal changes from L logic to H logic in a state where L logic is held as the synaptic weight, the latch circuit 46 changes the held synaptic weight from L logic to H logic. As indicated at time t₂₂, when the first setting signal changes from L logic to H logic in a state where H logic is held as the synaptic weight, the latch circuit 46 maintains the held synaptic weight at H logic.

As indicated at time t₂₃, when the second setting signal changes from L logic to H logic in a state where H logic is held as the synaptic weight, the latch circuit 46 changes the held synaptic weight from H logic to L logic. As indicated at time t₂₄, when the second setting signal changes from L logic to H logic in a state where L logic is held as the synaptic weight, the latch circuit 46 maintains the held synaptic weight at L logic.

In this manner, the latch circuit 46 can hold the synaptic weight indicating the first value or the second value, and can cause the held synaptic weight to change to indicate the first value or the second value when the first setting signal or the second setting signal is received.

FIG. 7 is a diagram illustrating the configuration of the weight control circuit 44.

The weight control circuit 44 includes a first probability generator 72, a first AND circuit 74, a second AND circuit 76, a timer 78, a second probability generator 80, a third AND circuit 84, a first inversion circuit 85, a first OR circuit 86, a second inversion circuit 90, a first D flip-flop 92, and a second D flip-flop 94.

The first probability generator 72 generates a first probability signal becoming H logic with a preset first probability. For example, the first probability generator 72 generates a random number every reference period, and determines whether or not the generated random number falls within a range of a given value which occurs with the first probability. Then, the first probability generator 72 generates a first probability signal that becomes H logic in a period during which the generated random number is in a range of the given value and becomes L logic in another period.

The first AND circuit 74 outputs a signal obtained by performing an AND operation on the reinforcement signal received from the learning instruction circuit 42 and the first probability signal output from the first probability generator 72. As a result, the first AND circuit 74 can output the reinforcement signal with the first probability.

The second AND circuit 76 outputs a signal obtained by performing an AND operation on the inhibitory signal received from the learning instruction circuit 42, the first probability signal output from the first probability generator 72, and a signal output from the first inversion circuit 85. Due to this, the second AND circuit 76 can output the inhibitory signal with the first probability on condition that the signal output from the first inversion circuit 85 is H logic.

The timer 78 outputs a timer signal that becomes H logic at every preset time and becomes L logic after a given time from H logic.

The second probability generator 80 generates a second probability signal becoming H logic with a preset second probability. For example, the second probability generator 80 generates a random number every reference period, and determines whether or not the generated random number falls within a range of a given value which occurs with the second probability. Then, the second probability generator 80 generates a second probability signal that becomes H logic in a period during which the generated random number is in a range of the given value and becomes L logic in another period.

The third AND circuit 84 outputs a signal obtained by performing an AND operation on the timer signal output from the timer 78 and the second probability signal output from the second probability generator 80. Due to this, the third AND circuit 84 can output, with the second probability, the timer signal generated every given time.

The first inversion circuit 85 inverts the signal output from the third AND circuit 84 and supplies the resulting signal to the second AND circuit 76. Due to this, the first inversion circuit 85 can output the inhibitory signal of the first probability from the second AND circuit 76 on condition that the timer signal output with the second probability is not H logic. That is, the first inversion circuit 85 can prevent the inhibitory signal from becoming H logic in a case where the timer signal output with the second probability is H logic. The first OR circuit 86 outputs a signal obtained by performing an OR operation on the signal output from the first AND circuit 74 and the signal output from the third AND circuit 84. Due to this, the first OR circuit 86 can output a signal of H logic when the reinforcement signal output with the first probability is H logic or when the timer signal output with the second probability is H logic. The second inversion circuit 90 outputs a signal obtained by inverting the firing signal.

At the timing at which the signal output from the second inversion circuit 90 changes from L logic to H logic, the first D flip-flop 92 fetches the value of the signal output from the first OR circuit 86 and stores the fetched value therein. Due to this, when the reinforcement signal is output with the first probability or when the timer signal is output with the second probability, the first D flip-flop 92 can fetch and store H logic. Moreover, when the reinforcement signal of the first probability has not been output and when the timer signal of the second probability has not been output, the first D flip-flop 92 can fetch and store L logic. Note that the first D flip-flop 92 fetches a value at the timing at which the firing signal changes from H logic to L logic.

At the timing at which the signal output from the second inversion circuit 90 changes from L logic to H logic, the second D flip-flop 94 fetches the value of the signal output from the second AND circuit 76 and stores the fetched value therein. Due to this, when the inhibitory signal is output with the first probability, the second D flip-flop 94 can fetch and store H logic on condition that the timer signal of the second probability has not been output. When the inhibitory signal of the first probability has not been output, the second D flip-flop 94 can fetch and store L logic. Note that the second D flip-flop 94 fetches a value at the timing at which the firing signal changes from H logic to L logic.

Such the weight control circuit 44 can output, as the first setting signal, a signal indicating the value stored in the first D flip-flop 92. Also, the weight control circuit 44 can output, as the second setting signal, a signal indicating the value stored in the second D flip-flop 94.

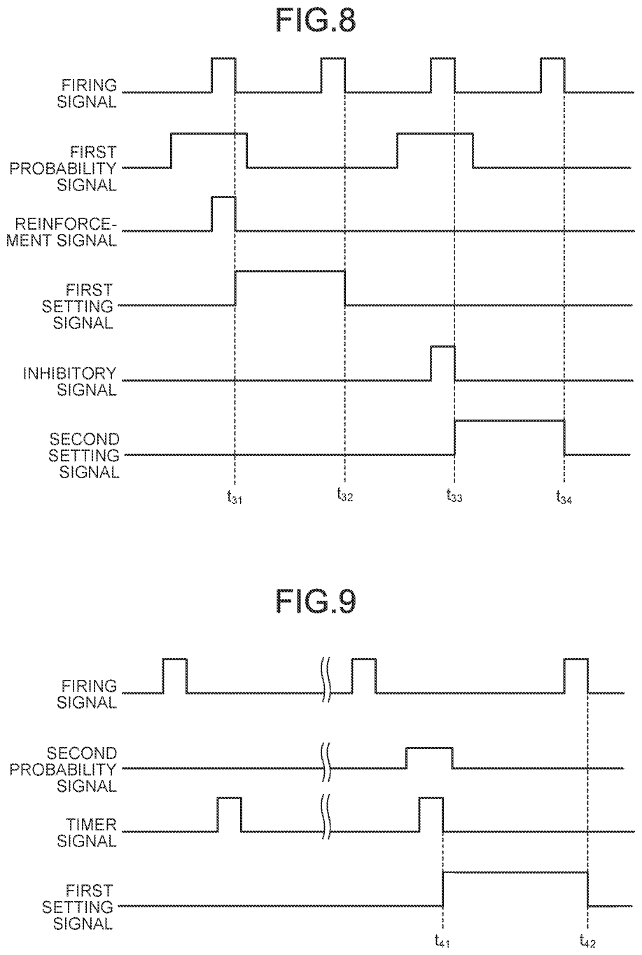

FIG. 8 is a diagram illustrating the first example of a timing chart of the signal of the weight control circuit 44.

When the internal potential V of the post-synaptic neuron circuit 24 is equal to or higher than the set potential V_{SET}, the weight control circuit 44 receives the reinforcement signal that changes in synchronization with the firing signal. When the reinforcement signal is H logic and the first probability signal generated from the first probability generator 72 is H logic at the timing (time t₃₁) at which the firing signal changes from H logic to L logic, the weight control circuit 44 fetches H logic into the first D flip-flop 92. Therefore, when the reinforcement signal is H logic and the first probability signal is H logic at the timing (time t₃₁) at which the firing signal changes from H logic to L logic, the weight control circuit 44 can output the first setting signal that becomes H logic from the timing (time t₃₁) at which the firing signal changes from H logic to L logic.

Moreover, when the first probability signal generated from the first probability generator 72 or the reinforcement signal is L logic at the timing (time t₃₂) at which the firing signal changes from H logic to L logic, the weight control circuit 44 fetches L logic into the first D flip-flop 92. Therefore, when the first probability signal generated from the first probability generator 72 or the reinforcement signal is L logic at the timing (time t₃₂) at which the firing signal changes from H logic to L logic, the weight control circuit 44 can output the first setting signal that becomes L logic from the timing (time t₃₂) at which the firing signal changes from H logic to L logic.

In this manner, when the reinforcement signal becomes H logic, that is, when the internal potential V of the post-synaptic neuron circuit 24 is equal to or higher than the set potential V_{SET}, the weight control circuit 44 can output the first setting signal for causing the synaptic weight to change to indicate the first value (e.g., H logic) with the first probability. In this case, the weight control circuit 44 can cause the synaptic weight to change to indicate the first value (e.g., H logic) at the timing at which the reinforcement signal changes from H logic to L logic, that is, at the timing at which the firing signal changes from H logic to L logic.

Moreover, when the internal potential V of the post-synaptic neuron circuit 24 is smaller than the set potential V_{SET}, the weight control circuit 44 receives an inhibitory signal that changes in synchronization with the firing signal. When the inhibitory signal is H logic and the first probability signal generated from the first probability generator 72 is H logic at the timing (time t₃₃) at which the firing signal changes from H logic to L logic, the weight control circuit 44 fetches H logic into the second D flip-flop 94. Therefore, when the inhibitory signal is H logic and the first probability signal is H logic at the timing (time t₃₃) at which the firing signal changes from H logic to L logic, the weight control circuit 44 can output the second setting signal that becomes H logic from the timing (time t₃₃) at which the firing signal changes from H logic to L logic.

Moreover, when the first probability signal generated from the first probability generator 72 or the inhibitory signal is L logic at the timing (time t₃₄) at which the firing signal changes from H logic to L logic, the weight control circuit 44 fetches L logic into the second D flip-flop 94. Therefore, when the first probability signal generated from the first probability generator 72 or the inhibitory signal is L logic at the timing (time t₃₄) at which the firing signal changes from H logic to L logic, the weight control circuit 44 can output the second setting signal that becomes L logic from the timing (time t₃₄) at which the firing signal changes from H logic to L logic.

In this manner, when the inhibitory signal becomes H logic, that is, when the internal potential V of the post-synaptic neuron circuit 24 is smaller than the set potential V_{SET}, the weight control circuit 44 can output the second setting signal for causing the synaptic weight to change to indicate the second value (e.g., L logic) with the first probability. Furthermore, in this case, the weight control circuit 44 can cause the synaptic weight to change to indicate the second value (e.g., L logic) at the timing at which the inhibitory signal changes from H logic to L logic, that is, at the timing at which the firing signal changes from H logic to L logic.

FIG. 9 is a diagram illustrating the second example of a signal timing chart of the weight control circuit 44. The timer signal becomes H logic at every preset time, and becomes L logic after a given time from H logic. The second probability signal becomes H logic at the second probability.

The first D flip-flop 92 acquires H logic when the firing signal is L logic, the timer signal is H logic, and the second probability signal is H logic. Therefore, in a case where the firing signal is L logic, the timer signal is H logic, and the second probability signal is H logic, the weight control circuit 44 can output the first setting signal that becomes H logic from the timing (time t₄₁) at which the timer signal changes from H logic to L logic to the timing (time t₄₂) at which the next firing signal changes from H logic to L logic.

In this manner, when the timer signal becomes H logic, that is, independent of the firing signal, the weight control circuit 44 can output the first setting signal for causing the synaptic weight to change to indicate the first value (e.g., H logic) with the second probability. In addition, such the weight control circuit 44 causes the synaptic weight to change to indicate the first value with the second probability in the period during which the firing signal is L logic. Due to this, the weight control circuit 44 can cause the synaptic weight to change to indicate the first value with the second probability without temporal interference with the learning operation for causing the synaptic weight to change when the firing signal becomes H logic.

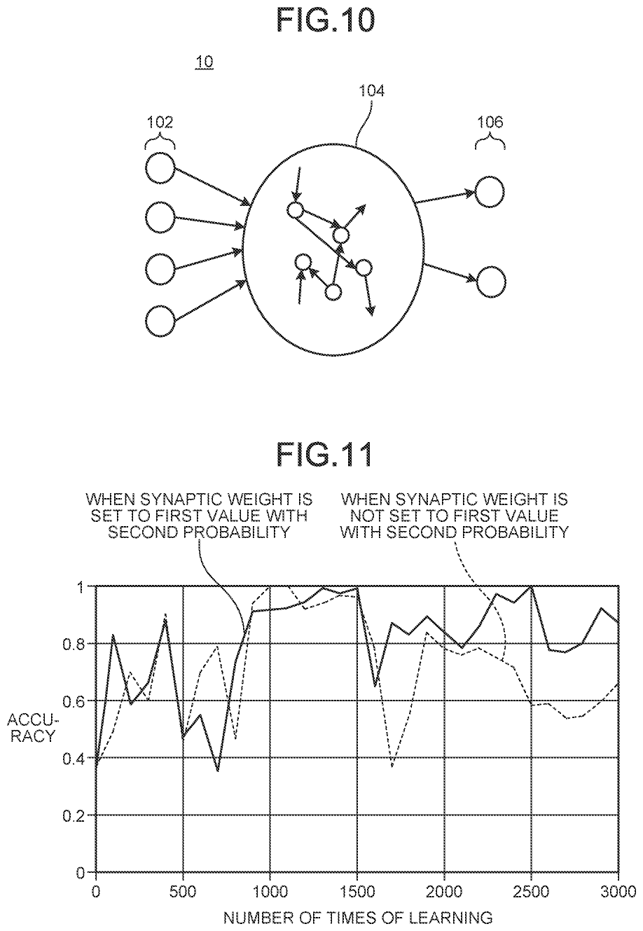

FIG. 10 is a diagram illustrating the configuration of a reservoir computing apparatus according to the embodiment. The reservoir computing apparatus includes an input layer 102, a reservoir layer 104, which is a recurrent neural network, and an output layer 106. The neural network apparatus 10 may be used as the reservoir layer 104 in such reservoir computing.

In this case, at least one of the synaptic circuits 20 included in the neural network apparatus 10 feeds back the output signal to supply it to the neuron circuit 14. That is, at least one of the synaptic circuits 20 supplies the output signal to the neuron circuit 14 of the neuron circuits 14, which is disposed in the preceding stage relative to the synaptic circuit 20 that supplies the output signal to the pre-synaptic neuron circuit 22.

FIG. 11 is a diagram illustrating accuracy with respect to the number of times of learning in a case where the neural network apparatus 10 is applied to the reservoir computing apparatus. Note that FIG. 11 illustrates, for the sake of comparison, the accuracy of a case where the synaptic weight is caused to change to indicate the first value with the second probability independent of the firing signal, and the accuracy of a case where the synaptic weight is not caused to change to indicate the first value with the second probability independent of the firing signal.

In the example of FIG. 11 illustrating the case that the neural network apparatus 10 is applied to the reservoir computing apparatus, when the number of times of learning exceeds 1550 times, the accuracy becomes higher in a case where the synaptic weight is caused to change to indicate the first value with the second probability than in a case where the synaptic weight is not caused to change to indicate the first value with the second probability.

As described above, the neural network apparatus 10 according to the present embodiment causes the synaptic weight stored in each of the synaptic circuits 20 to change to indicate the first value with the second probability independent of the learning of the synaptic weight according to the firing signal. Due to this, the neural network apparatus 10 according to the present embodiment can return the synaptic weight to the first value with the second probability even in a case where the synaptic weight is caused to erroneously change to indicate the second value because the pre-synaptic neuron circuit 22 did not fire by accident with respect to the synaptic circuit 20 that should have originally stored the synaptic weight of the first value by learning according to the firing signal. When such erroneous learning occurs, the internal potential held by the post-synaptic neuron circuit 24 hardly changes thereafter, so that it is difficult for the conventional device to return the synaptic weight to the correct first value. On the other hand, the neural network apparatus 10 according to the present embodiment can suppress deterioration in accuracy due to such erroneous learning and highly accurately learn the synaptic weight. As a result, the neural network apparatus 10 according to the embodiment can execute accurate inference.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A synaptic circuit comprising:
a weight storage circuit configured to store a synaptic weight indicating a first value or a second value; and
a transmission circuit configured to
receive a firing signal output from a pre-synaptic neuron circuit, and
supply an output signal to a post-synaptic neuron circuit, the output signal being obtained by adding, to the firing signal, influence of the synaptic weight stored by the weight storage circuit, wherein
the post-synaptic neuron circuit holds an internal potential varying in response to reception of the output signal, and
the weight storage circuit is configured to, when the firing signal is received from the pre-synaptic neuron circuit,
perform comparison to determine whether or not the internal potential held by the post-synaptic neuron circuit is equal to or higher than a set potential, and
cause the synaptic weight to change to indicate the first value or the second value with a first probability set in advance in accordance with a comparison result as to whether or not the internal potential is equal to or higher than the set potential, and
the weight storage circuit is configured to cause the synaptic weight to change to indicate the first value with a preset second probability regardless of whether or not the firing signal is received from the pre-synaptic neuron circuit.

2. The synaptic circuit according to claim 1, wherein the weight storage circuit is configured to cause the synaptic weight to change to indicate the first value with the second probability every preset time.

3. The synaptic circuit according to claim 1, wherein the transmission circuit is configured to,
when the firing signal is received from the pre-synaptic neuron circuit and the synaptic weight indicates the first value, supply the output signal to the post-synaptic neuron circuit, and,
when the firing signal is received from the pre-synaptic neuron circuit and the synaptic weight indicates the second value,
supply none of the output signal to the post-synaptic neuron circuit, or
supply the output signal to the post-synaptic neuron circuit at a timing later than a timing at which the output signal is supplied to the post-synaptic neuron circuit in a state where the synaptic weight indicates the first value.

4. The synaptic circuit according to claim 1, wherein
the post-synaptic neuron circuit increases the internal potential in response to reception of the output signal, and
the weight storage circuit is configured to, in response to reception of the firing signal from the pre-synaptic neuron circuit,
change the synaptic weight to indicate the first value with the first probability when the internal potential is equal to or higher than the set potential and the synaptic weight indicates the second value, and
change the synaptic weight to indicate the second value with the first probability when the internal potential is smaller than the set potential and the synaptic weight indicates the first value.

5. The synaptic circuit according to claim 1, wherein
the pre-synaptic neuron circuit outputs the firing signal becoming H logic at a firing start timing and becoming L logic after a given time elapses from the firing start timing, and
the weight storage circuit is configured to compare the internal potential of the post-synaptic neuron circuit with the set potential at a first timing at which the firing signal changes from L logic to H logic.

6. The synaptic circuit according to claim 5, wherein the weight storage circuit is configured to cause the synaptic weight to change to indicate the first value or the second value with the first probability on the basis of the comparison result at a second timing at which the firing signal changes from H logic to L logic immediately after the first timing.

7. The synaptic circuit according to claim 6, wherein the weight storage circuit is configured to cause the synaptic weight to change to indicate the first value with the second probability in a period during which the firing signal is L logic.

8. The synaptic circuit according to claim 1, wherein the second probability is lower than the first probability.

9. A neural network apparatus comprising:
neuron circuits each functioning as a neuron in a neural network; and
synaptic circuits each functioning as a synapse in the neural network, wherein each of the synaptic circuits includes
a weight storage circuit configured to store a synaptic weight indicating a first value or a second value; and
a transmission circuit configured to
receive a firing signal output from a pre-synaptic neuron circuit, and
supply an output signal to a post-synaptic neuron circuit, the output signal being obtained by adding, to the firing signal, influence of the synaptic weight stored by the weight storage circuit, wherein
the post-synaptic neuron circuit holds an internal potential varying in response to reception of the output signal, and
the weight storage circuit is configured to, when the firing signal is received from the pre-synaptic neuron circuit,
perform comparison to determine whether or not the internal potential held by the post-synaptic neuron circuit is equal to or higher than a set potential, and
cause the synaptic weight to change to indicate the first value or the second value with a first probability set in advance in accordance with a comparison result as to whether or not the internal potential is equal to or higher than the set potential, and
the weight storage circuit is configured to cause the synaptic weight to change to indicate the first value with a preset second probability regardless of whether or not the firing signal is received from the pre-synaptic neuron circuit.

10. The neural network apparatus according to claim 9, wherein at least one of the synaptic circuits supplies the output signal to a neuron circuit of the neuron circuits, which is disposed in a preceding stage relative to a synaptic circuit serving to supply the output signal to the pre-synaptic neuron circuit.
